(19) United States
(12) Patent Application Publication
(10) Pub. No.: US 2011/0252226 A1
(43) Pub. Date: Oct. 13, 2011

(54) PRESERVING USER PRIVACY IN RESPONSE TO USER INTERACTIONS

(75) Inventors: Paul Francis, Kaiserslautern (DE); Saikat Guha, Bangalore (IN)

(73) Assignee: Max Planck Gesellschaft zur Foerderung der Wissenschaften, Muenchen (DE)

(21) Appl. No.: 12/757,986

(22) Filed: Apr. 10, 2010

(51) Int. Cl. G06F 21/20; H04L 9/00; G06F 15/16

(52) U.S. Cl. 713/150; 709/203

(57) ABSTRACT

User privacy is preserved in response to user interactions with information items, such as advertisements, by controlling the behavior of a user's computer. Information items are associated with item response specifiers. Item response specifiers control the behaviors of the user's computer in response to user interactions with information items. Item response specifiers may be communicated to the user's computer with the associated information items or be retrieved separately by the user's computer from an information item broker or trusted third party. Item response specifiers may be cryptographically signed to ensure their integrity. Following a user interaction with an information item, the user's computer refers to the item response specifier to determine an appropriate privacy-preserving post-interaction behavior. Examples of privacy-preserving behavior include a silent privacy-preserving behavior, a proxied interaction privacy-preserving behavior, a partial proxied interaction privacy-preserving behavior, a delayed handoff privacy-preserving behavior, and a direct to provider privacy-preserving behavior.

### CROSS-REFERENCE TO RELATED APPLICATIONS

This application is related to U.S. patent application Ser. No. 12/552,549, filed Sep. 2, 2009, and entitled “Private, Accountable, and Personalized Information Delivery in a Networked System,” which is incorporated by reference herein.

### FIELD OF THE INVENTION

This invention relates generally to the field of information delivery on computer networks, and more particularly to systems and methods for efficiently providing individually targeted advertisements to users while protecting the users' privacy.

### BACKGROUND OF THE INVENTION

A major goal of advertising systems, Internet advertising included, is to accurately target the ad to the user. Unlike broadcast media like television and radio, which targets ads to groups of users, Internet ads can be targeted to individual users. This is good for the advertiser because less money is wasted presenting ads to users who don't care about them, and it is good for users because they are not bothered by ads that don't interest them.

However, individualized user targeting can also lead to loss of privacy. For example, information about which ads are shown to a specific user and which ads the user has interacted with (for example clicked on) is often gathered, for instance so that advertisers can monitor the effectiveness of their advertisements and pay for having the ad delivered. However, this information also leads to a loss of user privacy, as personal information about the user may be revealed or inferred from the user interaction.

Personally identifiable information is one type of personal information that may be revealed through user interactions with an advertisement. For example, when a user clicks on an ad, the user's web browser may be redirected to an advertiser web page for further information. In the course of providing this advertiser web page, the advertiser may identify the user's internet address. Because the ad was targeted to specific demographics, such as age, location, marital status, and/or interests, the advertiser can associate the internet address with other information about the user. Additionally, because internet addresses can be correlated with geographic locations, the advertiser may deduce the user's geographic location from his or her internet address. The user's internet address, an inferred geographic location, and user demographic information are examples of potentially unnecessary information provided to the advertiser that reduces the user's privacy.

Sensitive information is another type of personal information that may be revealed through user interactions with an advertisement. For example, a user may have a medical condition that he or she wishes to remain private. However, if the user were to click on an advertisement related to a drug or other product of interest to individuals with this medical condition, then the advertiser may associate other information provided by the user, such as his or her internet address, with this medical condition.

Over time and multiple user interactions, advertisers or data aggregators may collect enough information from the user to personally identify users based on their interactions with advertisements. Even if the user is cautious about providing personally identifiable information, advertisers may be able to identify a specific user based on a few demographic attributes. This may be used to assemble a profile on the user, which may include private and/or sensitive information received or deduced from the user's interactions.

Furthermore, a party could manipulate advertising systems to search for the geographic location of a specific individual by targeting advertisements to the known demographics and interests of the individual, as well as to a specific geographic area. Simply by learning that the advertisement was shown, the advertiser can deduce that the targeted individual is in the targeted geographic area.

Therefore, there is an unmet need to preserve user privacy by minimizing the amount of information provided to advertisers through user interactions, while still allowing advertisers to target advertisements to users.

### SUMMARY OF THE INVENTION

An embodiment of the invention preserves user privacy in response to user interactions with information items, such as advertisements, by controlling the behavior of a user's computer. Information items are associated with item response specifiers. Item response specifiers control the behaviors of the user's computer in response to user interactions with information items. Item response specifiers may be communicated to the user's computer at the same time as the associated information items or may be retrieved separately by the user's computer. In a further embodiment, the user's computer may retrieve item response specifiers from a trusted third party, such as a government agency or privacy advocacy group. Item response specifiers may be cryptographically signed to ensure their integrity.

Following a user interaction with an information item, the user's computer refers to the item response specifier to determine an appropriate privacy-preserving post-interaction behavior. Examples of privacy-preserving behavior include a silent privacy-preserving behavior, a proxied interaction privacy-preserving behavior, a partial proxied interaction privacy-preserving behavior, a delayed handoff privacy-preserving behavior, and a direct to provider privacy-preserving behavior.

The silent privacy-preserving behavior restricts the user computer to retrieving supplemental information that are already stored locally in response to a user interaction with an information item.

The proxied and partial proxied privacy-preserving behaviors allow the user computer to retrieve non-local supplemental information items through a proxy to preserve the user's privacy. Additionally, the proxied privacy-preserving behavior restricts the user's computer from transmitting personally identifiable information in response to the user interaction with the information item.

The delayed handoff privacy-preserving behavior allows the user computer to retrieve some supplemental information items from an information item broker. If the user decides to submit personally identifiable information, then the user computer may retrieve further supplemental information items from the information item provider. In a further embodiment, the supplemental information items accessed from the information item provider are not specific to a single information item, which further protects user privacy.

The direct to provider privacy-preserving behavior allows the user computer to retrieve supplemental information items from any source, including information item dealers and information item brokers.

### BRIEF DESCRIPTION OF THE DRAWINGS

The above and further aspects and advantages of the present invention may better be understood by referring to the following description taken in conjunction with the accompanying drawings, in which:

FIG. 1 is a diagram of a system according to an embodiment of the invention;

FIGS. 2A-2B illustrate example methods for specifying privacy-preserving responses to users interactions for information items;

FIG. 3 illustrates an example method of responding to user interactions with information items according to an embodiment of the invention; and

FIG. 4 illustrates an example computer system suitable for implementing embodiments of the invention.

### DETAILED DESCRIPTION

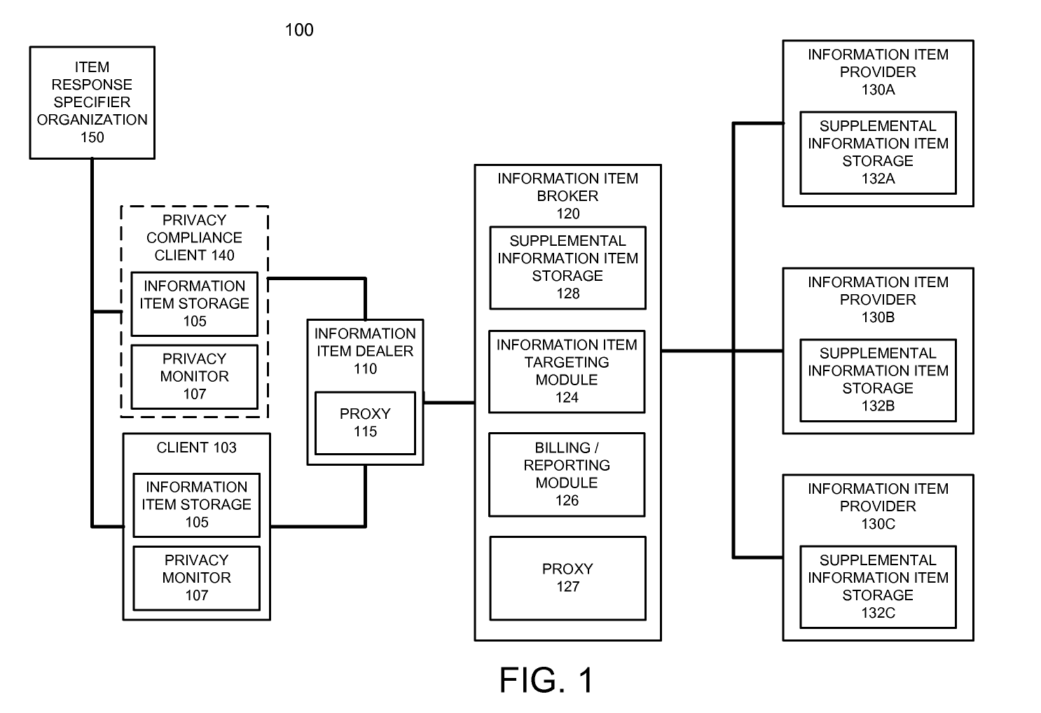

FIG. 1 is a diagram of an example system 100 according to an embodiment of the invention. System 100 includes one or more client systems, including client 103. Client 103 is a computer system. Examples of client 103 can include computers in the form of desktop or portable personal computers; mobile communication devices, including mobile telephones; network connected devices adapted to connect with televisions, including set-top boxes and game consoles; and any other electronic devices capable of communicating via wired and/or wireless network interfaces with electronic communications networks, including local-area networks and wide area networks, such as the Internet, cellular data networks, cable television data networks, and one-way or two-way satellite data networks.

Client system 103 includes an information item storage 105 for storing one or more information items. Example information items include text, images, video, animation, speech, audio, three-dimensional computer graphics data and images or animation rendered there from, hypertext, graphical user interface widgets or controls, interactive content such as games, and computer-executed logic in the form of programs or scripts. Information items may be used for advertisements or for other purposes, such as providing information to users or soliciting user feedback. Examples of information items can include pop-up and banner advertisements, as well as advertisements appearing within the display or user interface of an application.

Information item storage 105 may store information items targeted to the client 103 or the user of the client 103. Information items may be targeted at users or the client 103 based on users' demographic information, including factors such as age, gender, location, income, marital status, and interests, or attributes of the client 103. Additionally, information item storage 105 may store information items that are not targeted at any specific user or client. In an embodiment, information items storage 105 is implemented as a database or other data structure, such as an array.

In an embodiment, the client 103 includes a locally stored user profile that is used to retrieve information items tailored to the user's interests. In an embodiment, each information item may be associated with one or more categories that may be matched with user-preferred categories stored in the user profile.

In an embodiment, the client 103 also contains a privacy monitor 107 that tracks user interactions and insures that the user does not reveal more personal information than necessary or appropriate for the types of user interactions. Examples of personal information include sensitive information and personally identifiable information. Sensitive information is information that a user intends to keep private, such as a bank account number or medical information. Personally identifiable information is information that, although not private or confidential itself, may lead to a loss of anonymity when aggregated with other information provided by the user or inferred through user interactions with information items.

In one embodiment of the invention, the privacy monitor 107 is a standalone software application executed by the client in conjunction with other applications, such as web browsers and e-mail applications. In another embodiment, the privacy monitor 107 is integrated within another software application, such as a web browser or e-mail application. In still another embodiment, the privacy monitor 107 is integrated within an operating system or other system-level resource of the client 103.

User interactions can include presenting an information item to a user, such that the information item is visible, audible, or otherwise perceivable to the user; receiving input from the user in response to an information item, such as mouse interactions, keyboard inputs, touchpad or touchscreen inputs, joystick or game controller inputs, and voice commands; and purchasing goods or services electronically via the information item. User interactions can include receiving user inputs with respect to specific portions of the information item, such as a user selecting a graphical user interface button within an information item. User interactions may be processed by an application, such as a web browser or game client; a scripting language function executed within an application, such as Javascript; and/or an operating system or other system-level resource.

In response to user interactions with an information item, an embodiment of the client 103 may present one or more additional information items to the user. These additional information items presented to users in response to user interactions are referred to as supplemental information items. As discussed in detail below, supplemental information items may be retrieved from the information item storage 105, from supplemental information item storage 128 in information item broker 120, and/or from supplemental information item storages 132A, 132B, and 132C provided by information item providers 130A, 130B, and 130C, respectively. An information item may be associated with one or more supplemental information item identifiers, which may be used to locate and/or retrieve supplemental information items in response to user interactions with the information item. An example of a supplemental information item identifier is a URL. In response to a user interaction with an information item, an embodiment of a client 103 may request and/or receive multiple supplemental information items associated with the information item. Together, these multiple requests and/or receipts are referred to a supplemental information item session.

In an embodiment, the client 103 reports user interactions with information items to the information item broker 120. For example, if a user requests additional information associated with an advertisement by clicking on the advertisement, the client 103 may report this user interaction to the information item broker 120. The information item broker 120 may use this report of the user interaction for purposes of tracking and billing information item providers 130 using billing and reporting module 126 and/or for providing supplemental information items to the client 103 from supplemental information item storage 128 and/or 132. In a further embodiment, a supplemental information item may act as the target of additional user interactions, which may result in the retrieval and display of additional supplemental information items.

Embodiments of the invention maintain the privacy of the user of the client 103 by using one or more proxies and/or encryption to facilitate communications between the client 103 and the information item broker 120. In one embodiment, the client 103 encrypts communications with the information item broker 120 using a public encryption key associated with the information item broker 120. The encrypted communications are then sent from the client 103 to the information item broker 120 through one or more information item dealers 110, each of which includes a proxy 115. Upon receiving client communications via an information item dealer 110, an embodiment of the information item broker 120 uses a private encryption key to decrypt the communication from the client 103. Similarly, an embodiment of the information item broker 120 encrypts communications with the client 103 using a symmetric encryption key shared with the client 103 and sends the encrypted communications to the client 103 via one or more information item dealers 110. The client 103 may then decrypt communications from the information item broker 120 using a decryption key associated with the information item broker 120.

Alternative embodiments of the client 103 and information item broker 120 may use other types and combinations of public and private asymmetric keys and/or private symmetric keys to hide the contents of their communications from intermediaries such as proxies, information item dealers, or other entities.

In this embodiment of the invention, neither the information item dealer 110, which includes the proxy 115, nor the information item broker 120 may obtain enough information to violate the user's privacy. The use of the information item dealer 110 and proxy 115 hides the location of the client 103 from the information item broker 120 and information item providers 130. Also, the encrypted communications do not include any information identifying a specific user. Thus, the information item broker 120 receives no information that can identify the client 103. The information item dealer 110 knows the client's network address, but cannot decrypt the communications between the client 103 and the information item broker 120, so the information item dealer 110 learns nothing about the client 103 other than the fact that some interaction has taken place. As long as the operators of the information item broker 120 and information item dealer 110 do not collude, neither can learn which interactions have taken place. Further information on this technique of communicating via a proxy to maintain user privacy may be found in co-pending U.S. patent application Ser. No. 12/552,549, which is incorporated by reference herein.

In an embodiment, the billing/reporting module 126 of information item broker 120 uses the received notifications of user interactions with information items to provide one or more reports summarizing the interactions of one or more users. Embodiments of the information item broker 120 may provide reports to one or more of the information item providers 130.

Additionally, an embodiment of the information item broker 120 includes a proxy 127 for facilitating communications between the client 103 and the information item providers 130 while hiding the network location of the client 103 from the information item providers 130 and the network location of the information item providers 130 from the information item dealer 110.

As discussed above, one or more supplemental information items may be retrieved by a client in response to a user interaction. The retrieval of one or more supplemental information items is referred to as a supplemental information item session. In an embodiment, the information item broker 120 may use the information item dealer 110 and its proxy 115 to facilitate the communication of supplemental information items to the client 103 without violating the user's privacy. In an embodiment, supplemental information items retrieved from an information item provider 130 are encrypted so that the information item broker 120 and information item dealer 110 cannot eavesdrop on the supplemental information item session. Additionally, using the information item dealer 110 and proxy 115 for the supplemental information item session hides the identities of the information item providers 130 from the information item dealer 110. This prevents the information item dealer 110, which knows the identity of the client 103, from associating the client 103 with specific information item providers 130, which could compromise the user's privacy.

Information item providers 130 may receive one or more reports from the information item broker 120 that summarize user interactions with the provider's information items.

As discussed above, an embodiment of system 100 uses the information item dealer 110 and encryption to maintain user privacy with respect to the information item dealer 110, information item broker 120, and one or more information item providers 130. In an embodiment, there are several different types of communications between the client 103 and the information item broker 120. The first type of communication includes client requests for information item and/or supplemental information items from the information item broker 120 and/or information item providers 130, and responses from the information item broker 120 and information item providers 130 delivering the requested information items. In one example of this type of communication, the client 103 requests information items matching one or more categories, which are determined by the user profile maintained at the client 103. These categories correspond with general attributes of the user, such as a gender or approximate geographic location, demographic attributes of the user, and specific interests of the user identified by the client 103. In a further embodiment, the client 103 may request information items using broad categories or relatively few criteria, and then discard received information items that do not match more narrow categories or additional attributes of the user profile.

A second type of communications between client 103 and information item broker 120 includes reports of user interactions with information items. The types of communications may include the type of interaction, such as a user viewing or clicking on an information item; an information item identifier; and information about how the opportunity for interaction was provided, for instance the URL of the web site or web page containing banner ad space, or identifier of the game and location with the game world where the information item was presented.

An embodiment of the invention enables a client 103 to use a variety of different privacy-preserving post-interaction behaviors to further protect user privacy from information providers. These privacy-preserving behaviors include a silent privacy-preserving behavior, a proxied interaction privacy-preserving behavior, a partial proxied interaction privacy-preserving behavior, a delayed handoff privacy-preserving behavior, and a direct to provider privacy-preserving behavior. These privacy-preserving behaviors are explained in detail below. Regardless of the type of privacy-preserving behaviors used by the client, an embodiment of the invention proxies all of the communications between the client and the information item broker using the information item dealer.

In an embodiment, an information item, and optionally a supplemental information item, may be associated with an item response specifier. The item response specifier indicates how the privacy monitor 107 of the client 103 should handle user interactions with the associated information item. In an embodiment, the item response specifier selects one of the privacy-preserving behaviors to be performed by the client 103 in response to a user interaction with the associated information item.

The silent privacy-preserving behavior suppresses the client 103 from reporting user interactions to the information item broker 120 or any other entity. Additionally, an embodiment of the silent privacy-preserving behavior prevents the client 103 from retrieving any supplemental information items from the information item broker 120 or information item providers 130.

In an embodiment, if any supplemental information items are to be presented to the user in response to a user interaction with an information item having a silent privacy-preserving behavior, these supplemental information items are stored locally and in advance by the client 103 in information item storage 105. For example, the supplemental information items associated with an information item may be sent to the client 103 at approximately the same time by the information item broker 120 or the information item providers 130. When the user interacts with an information item having a silent privacy-preserving behavior, the client 103 retrieves one or more associated supplemental information items from its information item storage 105 for presentation to the user.

One advantage of the silent privacy-preserving behavior is that it provides very strong privacy; information item providers 130 does not learn if there are any users matching the categories of the information item. The silent privacy-preserving behavior also similarly limits the knowledge of the client 103 by the information item broker 120. One disadvantage of the silent privacy-preserving behavior is that it limits the advertising billing model. Because the information item broker 120 is not informed of any user interactions with these types of information items, the information item broker 120 cannot charge information item providers 130 or other entities for user interactions. Another disadvantage of the silent privacy-preserving behavior is that it does not give the information item provider 130 feedback about the effectiveness of the information item in eliciting a user interaction, such as how many users viewed or clicked on an information item.

The proxied privacy-preserving behavior reports user interactions with information items to the information item broker 120 and optionally the information item provider 130. However, the supplemental information item session established between the client 103 and the information item provider 130 is proxied by the information item dealer 110 and the information item broker 120.

In an embodiment of the proxied privacy-preserving behavior, the privacy monitor 107 of client 103 prevents any Personally Identifying Information (PH) from being conveyed by the user using the client 103. An embodiment of the privacy monitor 107 may block data submission protocol operations, such as HTTP GET and POST operations or URL parameters.

The advantage of the proxied privacy-preserving behavior is that no user PII (either network address or other PII) is revealed to the information item provider 130 or information item broker 120. A disadvantage of the proxied privacy-preserving behavior is that the information item provider 130 is not able to obtain PII, even if it is necessary and/or acceptable to the user. For example, a user may wish to purchase a product from the information item provider 130, and thus must provide his or her name, credit card number, mailing address, and so on.

The partial proxied privacy-preserving behavior addresses this disadvantage of the proxied privacy-preserving behavior by allowing the user to reveal PII to information item providers. Like the proxied privacy-preserving behavior, the partial proxied privacy-preserving behavior uses the information item dealer 110 and the information item broker 120 to proxy the supplemental information item session established between the client 103 and the information item provider 130. However, the privacy monitor 107 of client 103 allows the user to selectively reveal PII to an information item provider, for instance by allowing the HTTP GET or POST operations or URL parameters.

Once the user reveals PII to an information item provider, an embodiment of the invention may continue to proxy the supplemental information session between the client 103 and one of the information item providers 130 using the information item dealer 110 and information item broker 120. In a further embodiment, the supplemental information session may be converted to a direct connection between the client 103 and the appropriate information item provider. The direct connection between the client 103 and the appropriate information item provider allows the information item provider to identify the client's 103 network address. Nevertheless, the advantage of the partial proxied privacy-preserving behavior is that it protects user privacy in those cases where the user does not voluntarily provide PII (i.e. because he or she does not make a purchase), but allows the user to provide selected PII if the user desires.

The delayed handoff privacy-preserving behavior uses the information item broker 120 to provide one or more initial supplemental information items to the client in response to a user interaction. This hides the location and identity of the client and user from the associated information item provider following the user interaction. However, if the user desires to provide PII in response to either the information item or one of its related supplemental information items, the supplemental information item session is expanded to include the information item provider. In an embodiment, the supplemental information items initially provided by the information item broker to the client are exclusively associated with the information item associated with the user interaction. Upon supplying PII, the client is directed to retrieve one or more additional supplemental information items from the information item provider. These additional supplemental information items may be non-exclusively associated with more than one initial information item. Because of this, the information item provider may not be able to determine which specific information item was interacted with by the user. Thus, at least a portion of the user's privacy is maintained.

Embodiments of the delayed handoff privacy-preserving behavior may associate each information item with two types of supplemental information items: specific supplemental information items and common supplemental information items. A specific supplemental information item is retrieved by the client from the information item broker and may be exclusively associated with the information item. A common supplemental information item is retrieved by the client from one of the information item provider and may be associated with multiple information items, thus hiding much of the user's demographic information from the information item provider.

In an embodiment of the delayed handoff privacy-preserving behavior, the information item is associated with an identifier for a specific supplemental information item to be provided to the client by the information item broker following an user interaction. The specific supplemental information item may be associated with one or more identifiers for additional specific supplemental information items also provided by the information item broker. In this embodiment, the initial specific supplemental information item and/or one or more of the additional specific supplemental information items may be associated with an identifier for the common supplemental information item provided by the information item provider. Following a user interaction with a specific supplemental information, the client retrieves the common supplemental information item from the information item provider using the identifier associated with the specific supplemental information item provider.

In another embodiment of the delayed handoff privacy-preserving behavior, the information item is associated with identifiers for both the specific and common information items. In response to an initial user interaction with the information item, the client retrieves the specific supplemental information item from the information item broker using the first identifier associated with the information item. Following one or more subsequent user interactions with the specific supplemental information item and any additional specific supplemental information items, the client retrieves the common supplemental information item from the information item provider using the second identifier associated with the information item.

For the delayed handoff privacy-preserving behavior, all or a portion of the supplemental information item session may be proxied by the information item dealer and/or information item broker, including the communications between the client and an information item provider. In another implementation, communication of common supplemental information items occurs directly between the client and an information item provider.

The direct to provider privacy-preserving behavior does not proxy any communications in the supplemental information item session. In this privacy-preserving behavior, the client retrieves supplemental information items directly from the information item providers. Because the direct to provider privacy-preserving behavior does not protect the privacy of the user, it is appropriate for information items that are broadly targeted to non-sensitive demographic categories.

In an embodiment, item response specifiers are associated with information items to indicate to the client and/or the privacy monitor the appropriate privacy-preserving behaviors for information items. The item response specifier may be conveyed along with the information item itself by the information item broker or an information item provider. In another embodiment, the client may separately retrieve item response specifiers for the information items it receives.

In an embodiment, item response specifiers may be assigned to information items by a third party, such as a government agency, privacy advocacy group, trade association, or other type of organization. These types of organizations are referred to as item response specifier organizations 150. To ensure the integrity of item response specifiers, an embodiment of the item response specifier organization 150 may cryptographically sign item response specifiers so that clients can validate their integrity. A client 130 may retrieve item response specifiers from one or more item response specifier providers, such as item response specifier organization 150, the information item broker 120, or information item providers. Alternatively, the information item broker 120, or information item providers may retrieve signed or unsigned item response identifiers from the item response specifier organization 150 and distribute these along with the information items to the client 103.

In the case where the information item broker 120 distributes the item response specifiers unsigned, users, government agencies, privacy advocacy groups, and other item response organizations may wish to monitor information item brokers to insure that they are distributing the correct item response specifiers. An embodiment of the invention may monitor information item broker compliance using a privacy compliance client 140. The privacy compliance client 140 operates in a manner similar to that of client 103, but requests many different information items from the information item broker 120. The privacy compliance client 140 then analyzes these information items to ensure that the item response specifiers are appropriate based on the demographic categories associated with the information items and the type of information collected or exposed by user interactions with the information items.

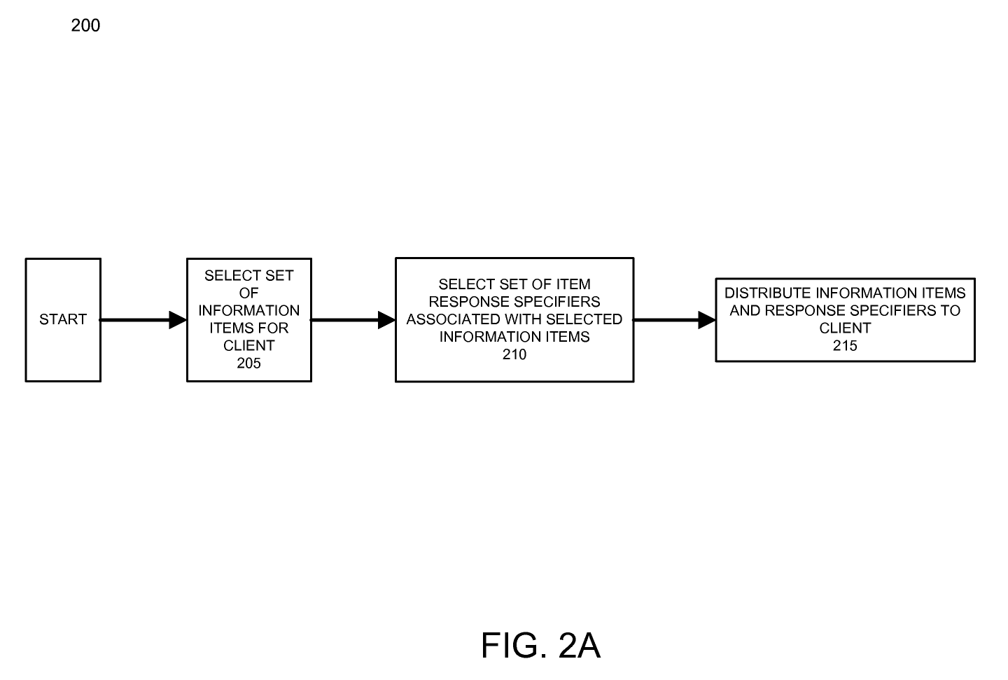

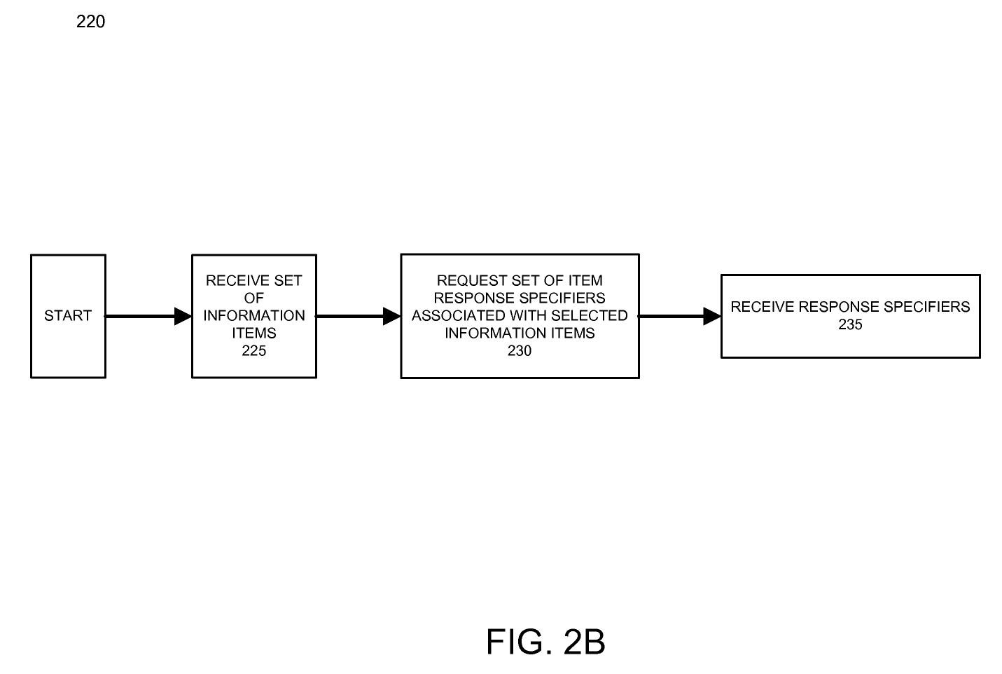

FIG. 2A illustrates an example method 200 for specifying privacy-preserving responses to user's interactions for information items. Method 200 begins with step 205 selecting a set of information items for a client. Step 205 may select information items based on broad or specific demographic categories or other user profile information provided by the client to the information item broker via the information item dealer. User profile information may be supplied by the user or gathered indirectly by monitoring the users requests and interactions for information items.

Step 210 selects a set of item response specifiers associated with the selected information items. In an embodiment, the item response specifiers are assigned to specific information items by an information item provider; a third party, such as a government agency, trade association, privacy advocacy group, or other organization; or the information item broker. In a further embodiment, item response specifiers are provided to the information item broker in conjunction with their associated information items. In another embodiment, the item response specifiers are retrieved by the information item broker from an item response specifier organization, either at the time of receipt of the information items or upon selection of the information items for delivery to a client. As discussed above, the item response specifiers may be cryptographically signed by the item response specifier organization to ensure their integrity.

Step 215 distributes the information items and the associated item response specifiers to the client. In an embodiment, information items and associated item response specifiers are communicated with the client through one or more proxies, such as that provided for by information item dealer, so as to protect the privacy of the user.

FIG. 2B illustrates an example method 220 for specifying privacy-preserving responses to users interactions for information items. Method 220 begins with step 225 receiving a set of information items. In an embodiment, a client receives encrypted information items from an information item broker via one or more proxies to protect user privacy. These encrypted information items may be decrypted using a shared symmetric decryption key, as described above.

Step 230 requests the set of item response specifiers for one or more of the received information items. An embodiment of step 230 may be performed upon receipt of one or more information items. Another embodiment of step 230 may be performed following a user interaction with one or more of the received information items. In the latter embodiment, step 230 may be restricted to requesting item response specifiers for only a portion of the received information items, such as the information items associated with a user interaction.

An embodiment of step 230 requests item response specifiers from an information item broker. Another embodiment of step 230 requests item response specifiers from one or more item response specifier organizations. In this embodiment, step 230 may request multiple item response specifiers assigned to the same information item, so as to compare different organizations' recommended privacy-preserving behaviors for the information item. In a further embodiment, a client's request for one or more item response specifiers may be proxied by an information item dealer and/or other entities on route to the item response specifier organization.

Step 235 receives one or more requested item response specifiers. In embodiments of step 235, the client may receive the item response specifiers directly from the item response specifier organization or indirectly via one or more other entities, such as an information item dealer. In a further embodiment, step 235 may validate the integrity of the received item response specifiers. For example, step 235 may retrieve a public decryption key of the item response specifier organization and use this key to decrypt all or a portion of a received item response specifier, thereby verifying its integrity.

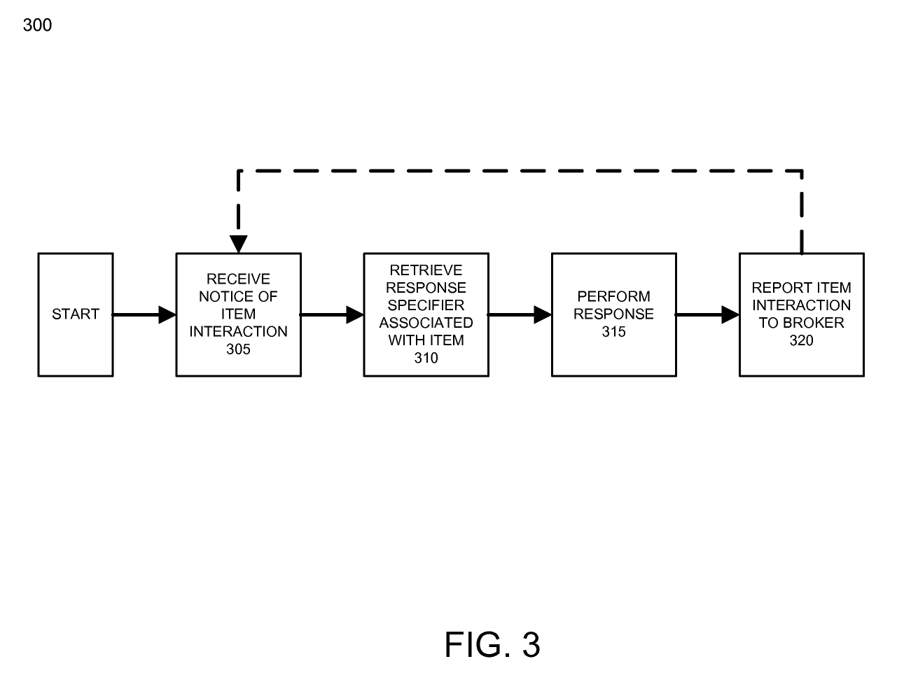

FIG. 3 illustrates an example method 300 of responding to user interactions with information items according to an embodiment of the invention. Method 300 starts with step 305 receiving a notification of a user interaction with an information item. As discussed above, user interactions can include presenting an information item to a user, such that the information item is visible, audible, or otherwise perceivable to the user; receiving input from the user in response to an information item, such as mouse interactions, keyboard inputs, touchpad or touchscreen inputs, joystick or game controller inputs, and voice commands; and purchasing goods or services electronically via the information item. The notification may be received from a client application, such as a web browser or game application, or client system resource, such as an operating system, library module, or event or application interface.

Step 310 identifies the information item associated with the user interaction and retrieves the item response specifier associated with this information item. In an embodiment, step 310 may retrieve the associated item response specifier from an information item storage located at the client. The associated item response specifier may have been provided to the client with the information item or retrieved separately from an item response specifier organization prior to the user interaction with this information item. In another embodiment, step 310 may retrieve the associated item response specifier from an item response specifier organization following the user interaction.

Step 315 performs the response as specified by the item response specifier. For the silent privacy-preserving behavior, an embodiment of step 315 restricts the client from retrieving any supplemental information items that are not already stored at the client. For the proxied interaction privacy-preserving behavior, supplemental information items may be retrieved from an information item broker and/or one or more information item providers, with all communications proxied by an information item dealer. Additionally, the proxied interaction privacy-preserving behavior may block the communication of personally identifiable information by the client to the information item broker or provider. The partial proxied interaction privacy-preserving behavior is similar, but allows the client to communicate personally identifiable information if desired. For the delayed handoff privacy-preserving behavior, supplemental information items are initially retrieved via a proxy from the information item broker. If the user desires to provide personally identifiable information, the client transfers the supplemental information item session to an information item provider to access common supplemental information items. For the direct to provider privacy-preserving behavior, the client is allowed to retrieve supplemental information items directly from the information item broker or information item providers.

Step 320 reports the user interaction to the information item broker. In an embodiment, step 320 may be omitted if the silent privacy-preserving behavior is associated with the information item. In an embodiment, step 320 reports the user interaction to the information item broker via an information item dealer, so that the user identity and location is hidden from the information item broker.

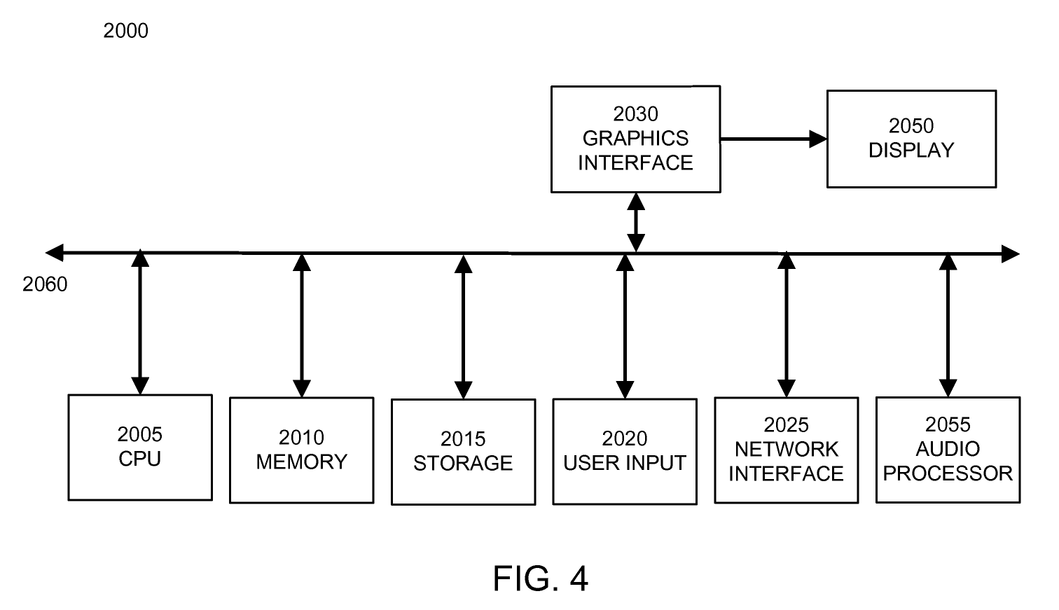

FIG. 4 illustrates an example computer system 2000 suitable for implementing embodiments of the invention. FIG. 4 is a block diagram of a computer system 2000, such as a personal computer, server computer, video game console, personal digital assistant, mobile communication devices such as mobile telephones, network connected devices adapted to connect with televisions such as set-top boxes, or other digital device, suitable for practicing an embodiment of the invention. Computer system 2000 includes a central processing unit (CPU) 2005 for running software applications and optionally an operating system. CPU 2005 may be comprised of one or more processing cores. Memory 2010 stores applications and data for use by the CPU 2005. Storage 2015 provides non-volatile storage for applications and data and may include fixed or removable hard disk drives, flash memory devices, and CD-ROM, DVD-ROM, Blu-ray, HD-DVD, or other magnetic, optical, or solid state storage devices.

User input devices 2020 communicate user inputs from one or more users to the computer system 2000, examples of which may include keyboards, mice, joysticks, digitizer tablets, touch pads, single or multitouch touch screens, still or video cameras, and/or microphones. Network interface 2025 allows computer system 2000 to communicate with other computer systems via an electronic communications network, and may include wired or wireless communication over local area networks and wide area networks such as the Internet. An optional audio processor 2055 is adapted to generate analog or digital audio output from instructions and/or data provided by the CPU 2005, memory 2010, and/or storage 2015. The components of computer system 2000, including CPU 2005, memory 2010, data storage 2015, user input devices 2020, network interface 2025, and audio processor 2055 are connected via one or more data buses 2060. Computer system 2000 may also include a location sensing device, such as a GPS receiver, adapted to determine the physical location of the computer system 2000.

A graphics interface 2030 is further connected with data bus 2060 and the components of the computer system 2000. The graphics interface 2030 is adapted to output pixel data for an image to be displayed on display device 2050. Display device 2050 is any device capable of displaying visual information in response to a signal from the computer system 2000, including CRT, LCD, plasma, OLED, and SED displays. Computer system 2000 can provide the display device 2050 with an analog or digital signal.

In embodiments of the invention, CPU 2005 is one or more general-purpose microprocessors having one or more homogenous or heterogeneous processing cores. Computer system 2000 may further implement one or more virtual machines for executing all or portions of embodiments of the invention.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method for specifying user privacy in association with an information item, the method comprising:
receiving an information item request from a client computer including a privacy monitor;
selecting at least one information item in response to the information item request;
selecting at least one item response specifier corresponding with the selected information item, wherein the item response specifier indicates a privacy-preserving behavior of a privacy monitor in response to a user interaction with the information item; and
transmitting the selected information item and selected item response specifier to the client computer.

2. The method of claim 1, wherein the item response specifier indicates a silent privacy-preserving behavior, such that the client computer is inhibited from communicating an indicator of user interaction with the selected information item.

3. The method of claim 2, comprising:
selecting at least one supplemental information item associated with the selected information item;
transmitting the supplemental information item to the client computer for presentation in response to user interaction with the selected information item.

4. The method of claim 1, wherein the item response specifier indicates a proxied privacy-preserving behavior, such that the client computer is directed to retrieve at least one supplemental information item via at least one proxy adapted to conceal the network address of the client computer and using encryption adapted to conceal contents of the supplemental information item from at least the proxy.

5. The method of claim 4, wherein the proxied privacy-preserving behavior is adapted to inhibit the client computer from communicating personally identifiable information in response to user interaction with the selected information item and the supplemental information item.

6. The method of claim 5, wherein inhibiting the client computer from communicating personally identifiable information includes inhibiting a data submission protocol operation.

7. The method of claim 1, comprising:
indicating a delayed handoff privacy-preserving behavior with the item response specifier;
associating the selected information item with a first supplemental information item identifier, wherein the first supplemental information item identifier is associated with a first supplemental information item stored by an information item broker;
associating the first supplemental information item with a second supplemental information item identifier, wherein the second supplemental information item identifier is associated with a second supplemental information item stored by an information item provider; and
transmitting the first supplemental information item identifier to the client computer.

8. The method of claim 1, wherein the item response specifier is cryptographically signed to ensure its validity.

9. A method for specifying user privacy in association with an information item, the method comprising:
receiving at least one information item from an information item broker;
transmitting an item response specifier request to an item response specifier provider;
receiving an item response specifier from the item response specifier provider, wherein the item response specifier indicates a first type of privacy-preserving behavior in response to a user interaction with the information item; and
associating the item response specifier with the information item.

10. The method of claim 9, comprising:
receiving a notification of the user interaction with the information item;
identifying the item response specifier associated with the information item; and
performing the first type of privacy-preserving behavior for the information item using the privacy monitor.

11. The method of claim 9, comprising:
receiving at least a second information item and a second item response specifier, wherein the second item response specifier indicates a second type of privacy-preserving behavior in response to a user interaction with the second information item; and
associating the second item response specifier with the second information item;
wherein the first type of privacy-preserving behavior is different than the second type of privacy-preserving behavior.

12. The method of claim 9, wherein the item response specifier provider is separate from the information item broker.

13. The method of claim 9, wherein the item response specifier indicates a silent privacy-preserving behavior, such that a client computer is inhibited from communicating an indicator of user interaction with the selected information item.

14. The method of claim 13, comprising:
receiving at least one supplemental information item associated with the information item;
storing the supplemental information item in the client computer for presentation in response to user interaction with the information item.

15. The method of claim 9, wherein the item response specifier indicates a proxied privacy-preserving behavior, such that a client computer is directed to retrieve at least one supplemental information item via a proxy adapted to conceal the network address of the client computer and using encryption adapted to conceal contents of the supplemental information item from at least the proxy.

16. The method of claim 15, wherein the proxied privacy-preserving behavior is adapted to inhibit the client computer from communicating personally identifiable information in response to user interaction with the selected information item and the supplemental information item.

17. The method of claim 16, wherein inhibiting the client computer from communicating personally identifiable information includes inhibiting a data submission protocol operation.

18. The method of claim 9, wherein the item response specifier indicates a delayed handoff privacy-preserving behavior with the item response specifier and includes a first supplemental information item identifier;
wherein the first supplemental information item identifier is associated with a first supplemental information item stored by an information item broker, wherein the first supplemental information item includes a second information item identifier; and
wherein the second supplemental information item identifier is associated with a second supplemental information item stored by an information item provider.

19. The method of claim 18, wherein the second supplemental information item is also associated with at least one additional information item.

20. The method of claim 9, comprising:
verifying the validity of the item response specifier using a cryptographic signature.
